(19) United States
(12) Patent Application Publication
(10) Pub. No.: US 2025/0125602 A1
(43) Pub. Date: Apr. 17, 2025

(54) MMODULAR SURFACE-MOUNTED ELECTRICAL FIXTURES FOR LOW-VOLTAGE DEVICES

(71) Applicant: Steiner Enterprises, Lafayette, IN (US)

(72) Inventors: Joshua E. DeWitt, Westfield, IN (US); Thomas P. Hicks, Lafayette, IN (US); Donald E. DeWitt, Syracuse, IN (US)

(21) Appl. No.: 18/917,008

(22) Filed: Oct. 16, 2024

Related U.S. Application Data
(60) Provisional application No. 63/544,479, filed on Oct. 17, 2023.

(51) Int. Cl. H02G 3/10; B60Q 3/82; B60R 16/023; H02G 3/14

(52) U.S. Cl. CPC H02G 3/10; B60R 16/023; H02G 3/14; B60Q 3/82

(57) ABSTRACT

A modular surface-mounted electrical fixture for a recreational vehicle (RV) includes a mounting bracket mounted within an opening in a wall of the RV, an electrical module including one or more electrical components selected from a plurality of different electrical components, and a mechanical interface between the mounting bracket and the electrical component for fixed mounting of the electrical component within the center opening of the mounting bracket manually and without using tools.

### PRIORITY CLAIM

This application is a utility filing from and claims priority to U.S. Provisional Application No. 63/544,479, filed on Oct. 17, 2023, the entire disclosure of which is specifically incorporated herein by reference.

### BACKGROUND

The present disclosure relates to surface- or wall-mounted fixtures for electrical devices, such as switches, outlets, sensors, etc., especially for use in recreational vehicles (RVs).

Access to electrical devices in RVs has evolved from limited hard-wired devices to electrical power strips to wall-mounted electrical outlets. Similarly, the electrical devices provided in RVs has evolved from small appliances to a wide range of appliances, devices and sensors. During this evolution, the wall-mounted electrical fixture has generally been an after-thought, with the primary concern being simply to provide low-voltage electricity to the devices.

As the RV market has grown, so too has the level of sophistication of the RV. There is a growing desire for an RV that is less of a mobile tent and more of a home away from home. Consequently, RVs are now provided with many access points for low-voltage devices. The result is frequently a hodge-podge of different electrical outlets at locations in the RV that may not meet the needs of the RV purchaser.

The customer demand for electrification of new RVs has been affected by a growing demand for electrical systems that are aesthetically pleasing and/or that blend with a desired look and feel for the interior of the RV. Current RVs have gravitated to interior designs that are more residential, with the look and feel of a house. There is a need for an RV electrical system that matches this look and feel and that can be easily customized to the needs and desires of every RV purchaser.

### SUMMARY

A modular surface-mounted electrical fixture, particularly a well-mounted fixture for a recreational vehicle (RV), comprises a mounting bracket configured to be mounted within an opening in a wall of the RV, the mounting bracket defining a center opening aligned with the opening in the RV wall. An electrical module is provided that is configured to be interchangeably mounted within the center opening of the mounting bracket. The electrical module includes one or more electrical components selected from a plurality of different electrical components. The modular fixture further comprises a mechanical interface for fixed mounting of the electrical component within the center opening of the mounting bracket. The mechanical interface allows the electrical component to be manually fixed to the mounting bracket without the use of tools. In one feature, the mechanical interface is configured for the electrical component to be pivoted into the center opening and snapped into the mounting bracket.

### BRIEF DESCRIPTION OF THE DRAWINGS

FIG. 1 is a perspective view of a dimmer switch module for incorporating into a modular surface-mounted electrical fixture for a recreational vehicle, according to one embodiment of the present disclosure.

FIG. 2 is a front view of the dimmer switch shown in FIG. 1.

FIG. 3 is a side view of the dimmer switch shown in FIG. 1.

FIG. 4 is a front perspective view of a mounting bracket for the modular wall-mounted fixture of the present disclosure.

FIG. 5 is an enlarged view of a retaining feature of the mounting bracket shown in FIG. 4.

FIG. 6 is an enlarged view of a retaining feature and a face plate mounting feature of the mounting bracket shown in FIG. 4.

FIG. 7 is an exploded view of the components of the modular wall-mounted electrical fixture prior to assembly.

FIG. 8 is an enlarged view of an upper retaining feature of the dimmer switch shown in FIG. 1.

FIG. 9 is an enlarged view of a lower retaining feature of the dimmer switch shown in FIG. 1.

FIGS. 10A-10H are front views of electrical fixture assemblies with various electrical devices mounted in the mounting bracket of the modular fixture of the present disclosure.

FIG. 11 is a schematic of a microcontroller unit for use in controlling the dimmer switch of FIG. 1.

FIG. 12A is a graph of light intensity vs. perceived light intensity as a function of a linear PWM duty cycle controlled dimmer switch.

FIG. 12B is a graph of light intensity vs. perceived light intensity as a function of an exponential PWM duty cycle controlled dimmer switch.

FIG. 12C is a graph of light intensity vs. perceived light intensity as a function of an PWM controlled dimmer switch according to the present disclosure that utilizes a parabolic PWM duty cycle.

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles disclosed herein as would normally occur to one skilled in the art to which this disclosure pertains.

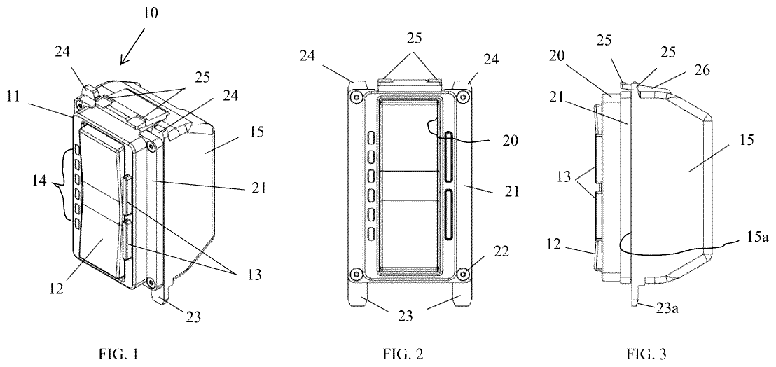

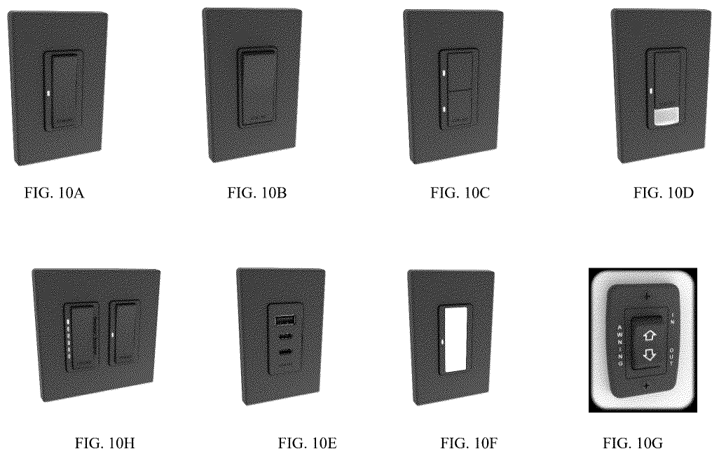

An electrical module 10 is shown in FIGS. 1-3 that is part of a modular surface-mounted electrical fixture, such as a wall-mounted fixture for a recreational vehicle (RV). The module in this embodiment is a dimmer switch, although it is understood that other modules, like the modules in FIGS. 10A-10H, can replace the dimmer switch module in FIGS. 1-3. The electrical module 10 includes a frame 11 that defines a receptacle 20 that receives the specific components of the particular module. In this embodiment, those components include an on-off toggle switch 12, up-down dimmer buttons 13 to increase or decrease the voltage provided to the light fixture, and a series of indicator lights 14 that indicate the level of brightness. A housing 15 is attached to the mounting plate 21 of the frame 11 and houses the circuitry and circuit board(s) associated with the particular module. The mating face 15a of the housing is removably attached to the mounting plate by a plurality of fasteners, such as screws 22. The housing includes wiring for connecting to the RV wiring system, wiring for connecting to an electrical device, such as a light or series of lights being controlled by the dimmer switch, and an arrangement of circuit boards providing the functions of the particular electrical module.

The frame 11, receptacle 20 and housing 15 can be configured to support components of other electrical devices, such as a digital switch in FIG. 10A, a rocker switch in FIG. 10B, dual on-off switches of FIG. 10C, an occupancy actuated on-off switch of FIG. 10D, a USB port of FIG. 10E, a simple on-off lighting switch of FIG. 10F, and an awning control switch of FIG. 10G. Each of these electrical devices have the same profile so that they can be interchangeably installed in the receptacle 20 and mounted to the frame 11. The frame 11 can be configured with a larger receptacle 20 to accommodate larger electrical modules, such as side-by-side switches or ganged switches as shown in FIG. 10H. Thus, in one aspect of the modular electrical fixture of the present disclosure, the frame 11 and housing 15 are themselves modular in that different electrical components can be mounted within the electrical module 10.

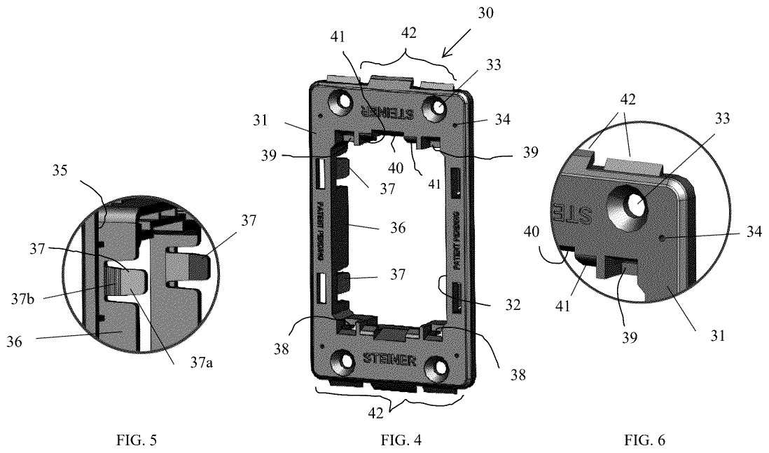

The electrical module 10 includes features that allows the module to be interchangeably installed in a surface-mounted mounting bracket 30, shown in FIGS. 4-6. In particular, the mating face 15a includes a pair of prongs 23 at the bottom of the housing 15. Each prong includes a rearward facing beveled surface 23a to facilitate insertion of the prongs into a pair of sockets 38 of the mounting bracket 30, as described in more detail herein. The housing 15 includes alignment tabs 24 projecting upward from the top of the housing at the mating face 15a, to be received within another pair of receptacles in the mounting bracket. Disposed between the alignment tabs are a pair of snap-in tabs 25 at the outboard end of a guide ramp 26. It can be appreciated that all of these elements can be integrally formed in the housing. Alternatively, the prongs 23, the snap-in tabs 25 and/or the guide ramp 26 can be incorporated into the mounting plate 21 of the frame 11. The frame 11 and housing 15 can be made of conventional non-conducting materials, such as PVC, formed in a conventional molding process.

The module 10 is configured to be snapped into the mounting bracket 30 that is mounted in an opening in a surface, such as a wall of the RV. As shown in FIGS. 4-6, the bracket includes a plate 31 that is sized to surround an opening cut into the wall of the RV that is large enough to receive the housing 15 of the electrical module 10. The plate defines a center opening 32 that is contiguous with the opening cut into the wall. The plate includes fastener openings 33 at the four corners of the plate 31 for receiving a fastener, such as a drywall screw, that is driven into the RV wall behind the plate. The plate can further include guide holes 34 that are used as a cutting guide when cutting the opening in the RV wall. The guide holes 34 are arranged to line up with the junction between the inner rim 35 and the side walls 36 of the plate, as shown in FIG. 5. It should be appreciated that the side walls 36 fit snugly in the wall opening, with the inner rim 35 abutting the wall at the perimeter of the wall opening. Interspersed within the side walls 36 are retaining tabs 37 that are angled slightly outward for an interference engagement RV wall opening. The inner ends 37a of the tabs are flared inward so that the ends can fit into the wall opening. As the side walls 36 of the mounting bracket are pushed into the wall opening, the ends 37a cause the tabs 37 to bend inward as they pass into the wall opening. The outer end of the tabs 37 define a gripping surface 37b that provides an enhanced friction grip between the tabs and the perimeter of the wall opening. The length of the gripping surfaces 37b correspond to the RV wall thickness. In the illustrated embodiment, two tabs 37 are provided at the opposite sides of the plate 31. The tabs can have an initial state in which the tabs are angled slightly outward so that the tabs apply an outward force against the perimeter of the wall opening when the mounting bracket is fully installed within the RV wall opening. In some cases, the frictional contact of the four tabs with the perimeter of the wall opening are sufficient to hold the mounting bracket and module within the wall. However, the plate 31 is preferably affixed to the RV wall using conventional fasteners through the fastener openings 33.

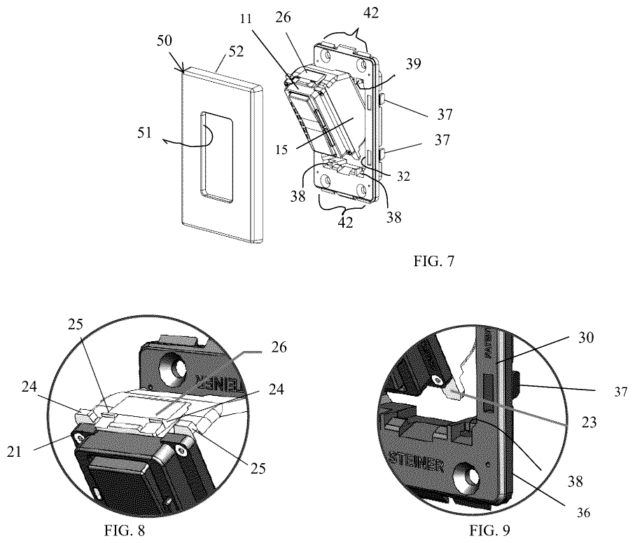

The plate 31 of the mounting bracket defines features to receive the mounting features of the electrical module 10. In particular, the plate 31 defines a pair of sockets 38 that are located and sized to receive the prongs 23 of the housing 15. Similarly, the plate defines a pair of alignment recesses 39, at the upper end of the plate center opening 32, that are located and sized to receive the alignment tabs 24 at the upper end of the mating face 15a of the housing. A guide channel 40 and a pair of flanking catch elements 41 are defined in the plate 31 in the space between the two alignment recesses 39. The guide channel is sized to receive the guide ramp 26 of the module 10. The catch elements 41 are configured and arranged for a snap-fit connection with the snap-in tabs 25. The top and bottom of the plate 31 include press-on latches 42 that are configured for snap-on engagement with the rim 52 of a faceplate 50 (see FIG. 7). Additional latches may be provided on the opposite sides of the plate 31.

Once the mounting bracket 30 is installed in the wall, the electrical module 10 can be installed in the mounting bracket, as illustrated in FIGS. 7-9. The housing 15 of the module 10 can be introduced into the center opening 32 of the mounting bracket plate with the prongs 23 aligned with the sockets 38 in the mounting bracket 30, as shown in FIG. 9. With the prongs partially introduced into the sockets, the module 10 can be pivoted about the sockets until the guide ramp 26 contacts the guide channel 40 at the top of the opening 32 of plate 31. The prongs 23 can then slide fully into the sockets 38 so that the alignment tabs 24 are aligned with the alignment recesses 39. The top of the module 10 can then be pushed fully into the mounting bracket until the snap-in tabs 25 snap into engagement with the catch elements 41. With the electrical module 10 fully seated within the mounting bracket, the face plate 50 can be snapped onto the latches 42 with the frame 11 of the module 10 in a close fit within the opening 51 of the face plate.

It is noted that the prongs 23 and sockets 38 are at the bottom of the electrical module 10 so that the top of the module is pivoted toward the mounting bracket to complete the assembly. It is possible for the prongs and sockets to be positioned at the top of the module 10 so that the bottom of the module is pivoted toward the mounting bracket to complete the assembly. This can be achieved by placing the mounting bracket 30 in the wall-opening upside-down relative to the orientation shown in FIG. 4, so that the sockets 38 are at the top of the bracket rather than at the bottom, as in FIG. 4. However, it is preferred to keep the prongs 23 and sockets 38 at the bottom of the module so that the user does not have to support the module to hold the prongs within the sockets as the module is pivoted inward.

It can be appreciated that the entire module can be assembled, and even mounted within the RV wall, without tools. The retaining tabs 37 and gripping feature 37b of the mounting bracket 30 can be configured to firmly retain the mounting bracket within the RV wall opening. (Of course, a preferred assembly would include fasteners through fastener openings 33 for a more secure fixation in the wall.) The electrical module and mounting bracket are provided with a mechanical interface for engagement of the module within the center opening of the mounting bracket. This mechanical interface includes at least the prongs 23, the sockets 38, the snap-in tabs 25 and the catch elements 41. The alignment tabs 24 and guide ramp 26 are optionally part of the mechanical interface. The electrical module 10 can be introduced into the mounting bracket by sliding the prongs 23 into the sockets 38, and then pivoting the mounting plate 21 toward the plate 31 of the mounting bracket until the snap-in tabs 25 of the module 10 click into the catch elements 41 of the mounting bracket. The face plate 50 can then be clicked onto the press-on latches 42 at the top and bottom of the mounting bracket. Assembly is quick and easy.

As mentioned above, the electrical module 10 can take on a variety of functions, such as a digital switch (FIG. 10A), a rocker switch in (FIG. 10B), dual on-off switches (FIG. 10C), an occupancy actuated on-off switch (FIG. 10D), a USB charging station (FIG. 10E), a simple on-off lighting switch (FIG. 10F), and an awning control switch (FIG. 10G). In these embodiments, the same frame 11 and housing 15 can be used to support electrical devices other than the switches 12, 13 and indicator 14 shown in FIG. 1. Likewise, the same mounting bracket 30 can be employed to mount the electrical module in an RV wall. However, the ganged switches shown in FIG. 10H require modifications to the mounting bracket to accommodate the additional switch and increased width of the particular module. The same construction for the frame 11 and housing 15 can be used for the individual switches, but the mounting bracket 30 and cover plate 50 would be modified to accommodate the additional switch. The bracket can be modified to accommodate three or more ganged switches. Nevertheless, the modified bracket can be installed in the RV wall opening in the same manner, as can the modified cover plate. It is also contemplated that only the cover plate is modified for a ganged switch. In this instance, a new electrical module 10 is to be mounted next to an existing electrical outlet or switch. A new wall opening can be formed adjacent to the existing outlet/switch and the electrical module/mounting bracket combination can be installed in that new wall opening. A wall plate with two openings 51 can be mounted on the newly-installed module/mounting bracket combination with the extra opening 51 aligned with the existing outlet/switch.

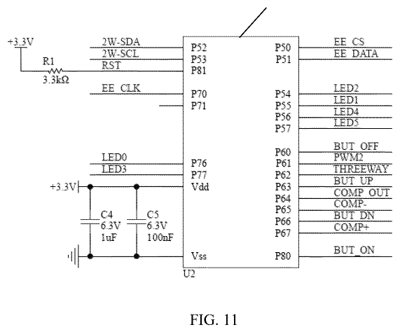

In one feature of the present disclosure, the dimmer switch shown in FIG. 1 includes electronics contained with the housing 15 that controls the application of current to the lighting fixture to which the module 10 is connected. The electronics includes a microcontroller unit (MCU) 60 according to the schematic shown in FIG. 11. The MCU 60 receives data from an EEPROM through inputs EE CS and EE DATA, and a clock signal from the EEPROM at EE CLK. The MCU includes software stored in the EEPROM and/or firmware that performs the duty cycle calculations for the pulse-width modulation (PWM) output voltage signal PWM2. The PWM voltage signal can be provided to an output MOSFET connected to the lighting being controlled by the MCU. The MCU 60 generates signals for the indicator lights 14 at outputs LED0-LED5, and receives inputs from the switch 12 and buttons 13 at inputs BUT_OFF, BUT_UP, BUT_DN and BUT_ON. In the illustrated embodiment, the MCU 60 can be connected to a 3.3V power supply that is connected to the RV power supply. The MCU 60 can be implemented in a circuit board and circuit array contained within the housing 15. It can be appreciated that a similar MCU can be provided for each of the electric modules shown in FIGS. 10A-10H, configured for the particular function(s) of the modules.

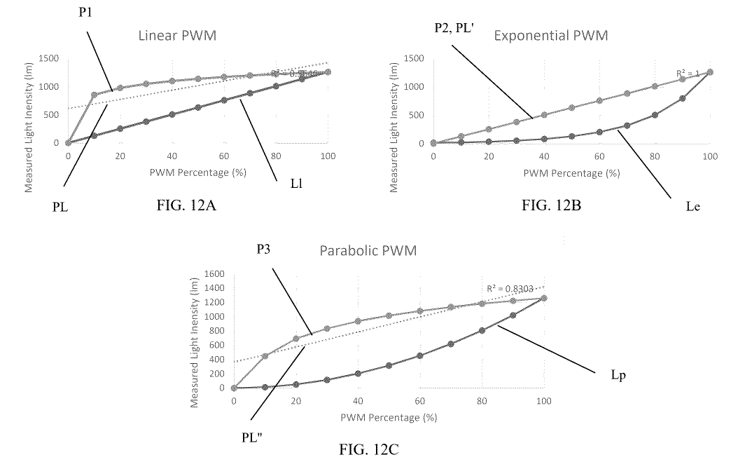

As is known in the art, the dimmer function of the switch can be controlled by a pulse-width (PWM) modulated signal generated by the MCU 60 in the electronics of the dimmer switch. In this instance, the up-down dimmer buttons 13 control an electronic signal provided to the PWM controller which, in turn, controls the analog current provided to the lighting fixture. It is known that increase in brightness perceived by the human eye is not linear. In other words, the human eye perceives a greater increase in brightness in the first 30-40% of the increase in the PWM signal while the remaining 40-100% is perceived to show little change in brightness. This phenomenon is illustrated in the graph of FIG. 12A, in which the lumens emitted by the light L1 increases linearly from zero to 100% of the light output based on a linear duty cycle for the PWM signal. The intensity of the light as perceived by the human eye is represented by the discontinuous line P1 in which the perceived brightness increases to about 70% of the maximum brightness of the light within the first 10% of the PWM signal. The line PL is a linear approximation of the perceived light through the entire PWM cycle. Thus, when the user sets the dimmer switch to a position corresponding to 15% brightness, the linear duty cycle equation yields a perceived brightness that is 70% of the maximum brightness. It can be appreciated that it is difficult for the user to set the dimmer switch in the 0-10% range of the PWM cycle to achieve a brightness less than 70% of maximum. Any movement of the dimmer switch past this initial 10-15% produces only a modest increase in brightness. So, while a linear PWM signal is easy to generate, the result is a dimmer switch that has a limited functionality.

In order to compensate for the skewed and generally flat intensity P1 perceived by the human eye using a linear PWM duty cycle, and to increase the useful range of the PWM signal, an exponential equation for the PWM duty cycle is implemented, as illustrated in FIG. 12B. The exponential PWM signal Le produces a linear perceived light curve P2 that matches the linear approximation PL′. Thus, then the user adjusts the dimmer switch to 40% brightness, the exponential PWM signal generates a brightness that is approximately 40% of the maximum brightness of the light. The exponential PWM signal thus generates a perceived light P2 that is nearly identical to the linear perceived light value PL′.

Although the exponential PWM duty cycle of FIG. 12B provides an optimal dimmer switch control, the equation to generate such a signal consumes a significant amount of memory and processing power in the digital processor controlling the light. Supporting the more memory intensive exponential PWM equations requires a higher end microprocessor in the controller, which in turn makes the dimmer switch component more expensive. It is more cost-effective to utilize a low-end and cheaper microprocessor to implement the PWM control for the lighting. It has been found that a parabolic PWM duty cycle, such as the signal Lp shown in FIG. 12C, requires much less memory than the exponential PWM equation of FIG. 12B. Moreover, as demonstrated in the graph of FIG. 12C, the light intensity perceived by the user, represented by line P3, shows a more linear curve that is closer to the linear light value PL″ than the linear signal in FIG. 121A. Thus, in one aspect of the present disclosure, the dimmer switch electrical module includes a controller with a microprocessor programmed to implement a parabolic duty cycle equation to generate the PWM signal that controls the intensity of the light connected to the switch. The parabolic equation for the PWM signal requires less memory and processor power to implement than the exponential PWM equation, while producing an increase in light intensity that is more linear than the conventional linear PWM system. As seen in FIG. 12C, the perceived light intensity noticeably changes in the middle range of the dimmer switch, where the majority of the fine light intensity adjustment will occur. This allows the dimmer switch of the present disclosure to allow meaningful light intensity control over the entire parabolic PWM cycle.

The present disclosure should be considered as illustrative and not restrictive in character. It is understood that only certain embodiments have been presented and that all changes, modifications and further applications that come within the spirit of the disclosure are desired to be protected. For instance, the disclosed embodiments relate to electrical devices mounted in the walls of an RV. However, the modular surface-mounted fixture can be mounted in the wall of a building as well as in the surface of a structure, such as an article of furniture.

What is claimed is:

1. A modular surface-mounted electrical fixture for a recreational vehicle (RV), comprising:
a mounting bracket configured to be mounted within an opening in a wall of the RV, the mounting bracket defining a center opening aligned with the opening in the RV wall;
an electrical module configured to be mounted within the center opening of the mounting bracket when the mounting bracket is mounted within the RV wall opening, the electrical module including one or more electrical components selected from a plurality of different electrical components; and
a mechanical interface between said mounting bracket and said electrical component for fixed mounting of the electrical component within the center opening manually and without the use of tools, said mechanical interface configured for the electrical component to be pivoted into the center opening and snapped into the mounting bracket.

2. The modular surface-mounted electrical fixture of claim 1, wherein:
said electrical module includes a frame defining a receptacle for receiving said one or more electrical components and a housing attached to said frame to contain circuitry and circuit board(s) associated with said one or more electrical components.

3. The modular surface-mounted electrical fixture of claim 1, wherein said mechanical interface includes:
a pair of prongs extending from one end of said electrical module;
a pair of snap-in tabs extending from an opposite end of said electrical module;
a pair of sockets defined in said mounting bracket at one end of said center opening, said pair of sockets located and sized to slidably receive said pair of prongs therein; and
a pair of catch elements defined in said mounting bracket at an opposite end of said center opening, said pair of catch elements located and sized for snap-fit engagement with said pair of snap-in tabs,
wherein, said pair of prongs and said pair of sockets are configured so that said electrical module can pivot toward the center opening when the pair of prongs are partially disposed within said pair of sockets.

4. The modular surface-mounted electrical fixture of claim 1, wherein said mechanical interface further includes:
a pair of alignment tabs extending from said one end of said electrical module, said pair of alignment tabs flanking said pair of snap-in tabs; and
a pair of recesses defined in said mounting bracket at said opposite end of said center opening, said pair of recesses located and sized to receive said pair of alignment tabs therein when said electrical module is installed within said center opening of said mounting bracket.

5. The modular surface-mounted electrical fixture of claim 1, further comprising:
a cover plate configured for snap-on engagement to said mounting bracket, said cover plate defining an opening for access to said electrical module therethrough,
wherein said mounting flange defines a latch on at least two opposite ends of said mounting flange, each latch configured for snap-on engagement with said cover plate.

6. The modular surface-mounted electrical fixture of claim 1, wherein said plurality of different electrical components include a dimmer switch, a digital switch, a rocker switch, dual on-off switches, an occupancy actuated on-off switch, a USB port, a simple on-off lighting switch, an awning control switch and ganged switches.

7. The modular surface-mounted electrical fixture of claim 1, wherein said mounting bracket includes a plate defining said center opening, said plate including:
side walls projecting from said plate at opposite sides of said center opening, said side walls positioned and sized to fit within the opening in the RV wall; and
retaining tabs projecting from said plate adjacent said side walls, said retaining tabs angled outward from said center opening for interference engagement with the RV wall within the wall opening, each retaining tabs including a gripping surface for enhanced frictional contact with the RV wall when the mounting bracket is pressed into the RV wall opening.

8. The modular surface-mounted electrical fixture of claim 1, wherein said mounting bracket, said electrical module, excluding the one or more electrical components, and said mechanical interface are formed of moldable non-conducting plastic or resin material.

9. A surface-mounted dimmer switch for connecting a light fixture to a power supply, comprising:
a pair of buttons for increasing and decreasing a voltage provided to the light fixture; and
a pulse width modulation (PWM) controller for controlling the voltage to the light fixture in response to operation of the pair of buttons, wherein the PWM controller implements a parabolic duty cycle to produce a parabolic increase in voltage provided to the light fixture.
